(19) United States
(12) Patent Application Publication
(10) Pub. No.: US 2007/0204469 A1
(43) Pub. Date: Sep. 6, 2007

(54) Clipping Device and Comb Unit

(75) Inventors: Drazen Stjepan Caric, Klagenfurt (AT); Hannes Floessholzer, St. Paul (AT)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 11/629,714

(22) PCT Filed: Jun. 7, 2005
(86) PCT No.: PCT/IB05/51851

§ 371 Date: Dec. 13, 2006

(30) Foreign Application Priority Data
Jun. 15, 2004 (EP) 04102711.1

(51) Int. Cl. B26B 19/00

(52) U.S. Cl. 30/201

(57) ABSTRACT

To provide for different cut width, it is proposed to use a cover means (4) to be mounted on the casing (2) and/or cutting unit (3) of a clipping device for partially covering the cutting members (31) of the cutting unit (3) to reduce the cut width. The cover means (4) may be, for example, a comb unit (41) or movable covering parts (42, 44) integrated in the cutting unit (3).

The invention relates to a clipping device as used for cutting hair, trimming beards or trimming animals and to a comb unit for such a clipping device.

Clipping devices are widely used for cutting hair, especially for short haircuts and around the ears or for trimming beards. Dogs, e.g. poodles or other animals may be trimmed, too, with the help of a clipping device.

Generally used clipping devices have a cutting unit with two blades moved relatively to one another with help of a motor. The cutting device is normally mounted on a casing housing the motor or batteries as power supply for the clipping device. To define a certain cut length, a comb unit is mounted on the casing covering the cutting unit. The actual cutting length is defined by the length of the comb unit's teeth. The hair length is equivalent to the distance of the blades to the skin whereon the comb unit fixed on the casing is applied for cutting.

Another important parameter is the cut width. The regularly provided cut width is defined by the width of the blades and in particular appropriate for cutting hair on larger areas such as the beard on the cheeks or hair on top of the head. But for some application like trimming a moustache or cutting hair around the ears, the cut width might be too large for a precise cut without the danger of injuring the skin. Another application, where too large a cut width is rather inconvenient, is the case of first testing whether the actual cutting length is suitable.

U.S. Pat. No. 6,378,210 B1 suggests a solution to this problem. A pattern designer shaver system is disclosed that includes a base unit for driving a number of user attachable trimmer and shaver accessories of varying width. Each trimmer attachment includes a conventional hair trimmer head couplable to the off-set output shaft by an attachment slot formed into the bottom thereof and a trimmer attachment housing having an internal threaded base unit coupling end having internal trimmer attachment threads that are companionate with the base unit threads. The trimmer attachments are substantially identical except for the trimmer width.

A major drawback of this solution is the technically complex coupling of the trimmer attachment to the base unit, which is prone to malfunction.

It is an object of the invention to provide an improved clipping device and a comb unit for such a clipping device.

In a first aspect, the invention provides a clipping device comprising a casing, a cutting unit at one end of the casing including one or more cutting members providing a given cut width and a cover means to be mounted on the casing and/or the cutting unit for covering the cutting members to reduce the cut width. The cover means may be configured as single part or as a combination of different parts.

The clipping device according to the invention offers a wide range of possible applications, as the cut width is varied with help of the cover means. The clipping device with mounted cover means is particularly useful for testing the cut length without removing to much hair or for trimming or cutting hair with high precision, e.g. around the ears. The clipping device with removed cover means allows for the maximum cut width. The reduced cut width is achieved by the cover means without the need for various trimmer attachments and complex coupling of these as in the prior art.

In preferred embodiments of the present invention, the cover means is configured as comb unit attachable to the casing and/or cutting unit. The cover means being a removably connected comb unit allows for exchanging it with a conventional comb unit in case a maximal cut width is needed. Preferably, the comb unit includes a teeth part with closed interstices shielding the cutting members. This makes the hair to be cut stand upright, but only the hair not at the part of the comb unit having teeth with closed interstices will actually be reached by the cutting unit and cut.

The cover means may be attachable or fixed to the cutting unit and/or the casing. In case the cover means is fixed, in preferred embodiments, it can be moved between a position providing the given cut width and a position providing a reduced cut width. By being fixed, the cover means cannot get lost or be forgotten. It then is preferably integrated into the cutting unit, thus preventing damage from the cover means. Attached cover means have the advantages that the production costs are low and that various cover means of different dimensions can be provided, thus defining different cut widths for one cutting unit.

In preferred embodiments, the cover means may include two or more parts, the reduced cut width being substantially equal to the distance between said two parts. By pushing or actuating or mounting said two parts it is easily possible to switch between reduced and non-reduced cut width.

In preferred embodiments, the cover means includes two or more parts that are independently movable in a direction perpendicular to the cuttings members, each defining a reduced cut width. This is especially convenient, if different users use the same clipping device, some being sinistrals, some being right handers, or if the user wants to cut hair around one ear and then around the other ear

In preferred embodiments, the cover means is movable in a direction substantially parallel to the cutting members in order to change the location of the covered part of the cutting members with respect to the casing. This embodiment as well is especially convenient, if different users use the same clipping device, some being sinistrals, some being right handers, or if the user wants to cut hair around one ear and then around the other ear.

In another aspect, the invention provides a comb unit for a clipping device according to the invention that is attachable to the casing and/or the cutting unit to cover the one or more cutting members of the cutting unit to reduce the cut width, wherein it includes a teeth part with closed interstices shielding the cutting members. This has the advantage that the comb unit according to the invention may be exchanged with a conventional comb unit depending on which cut width is needed.

A preferred embodiment of the present invention is described herein with reference to the drawings wherein:

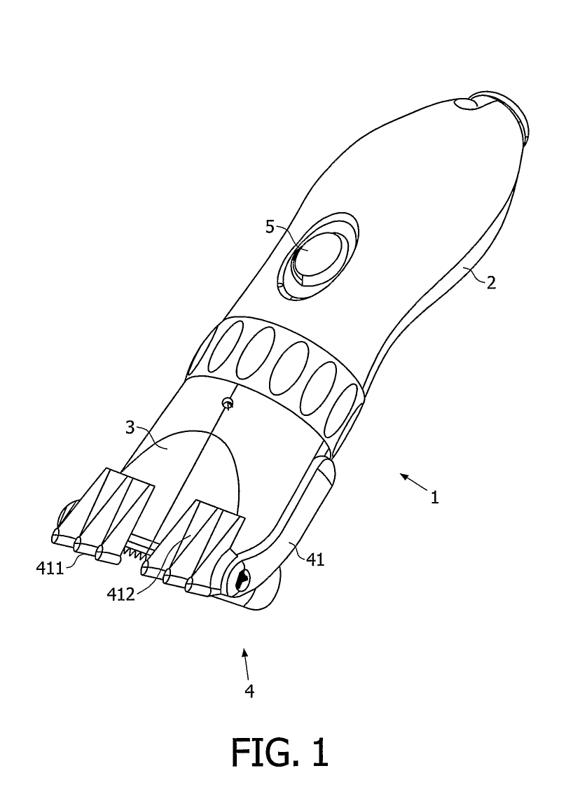

FIG. 1 shows a first embodiment of the clipping device with a cover means arranged as comb unit in a first position;

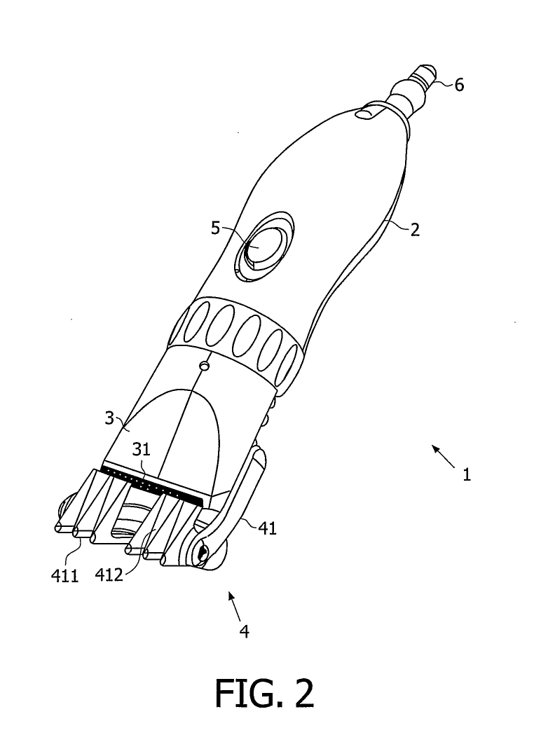

FIG. 2 shows the first embodiment of the clipping device with a cover means arranged as comb unit in a second position;

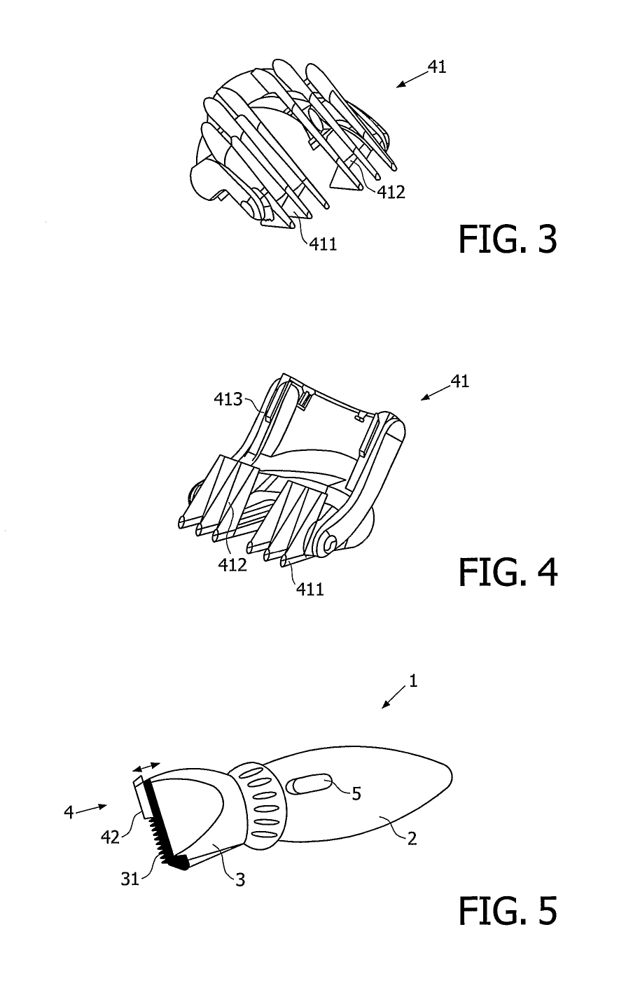

FIG. 3 shows a first perspective of comb unit according to the invention;

FIG. 4 shows a second perspective of a comb unit according to the invention;

FIG. 5 shows a second embodiment of the clipping device with a cover means arranged as movable shield;

FIG. 6 shows a third embodiment of the clipping device with a cover means arranged as removable cover;

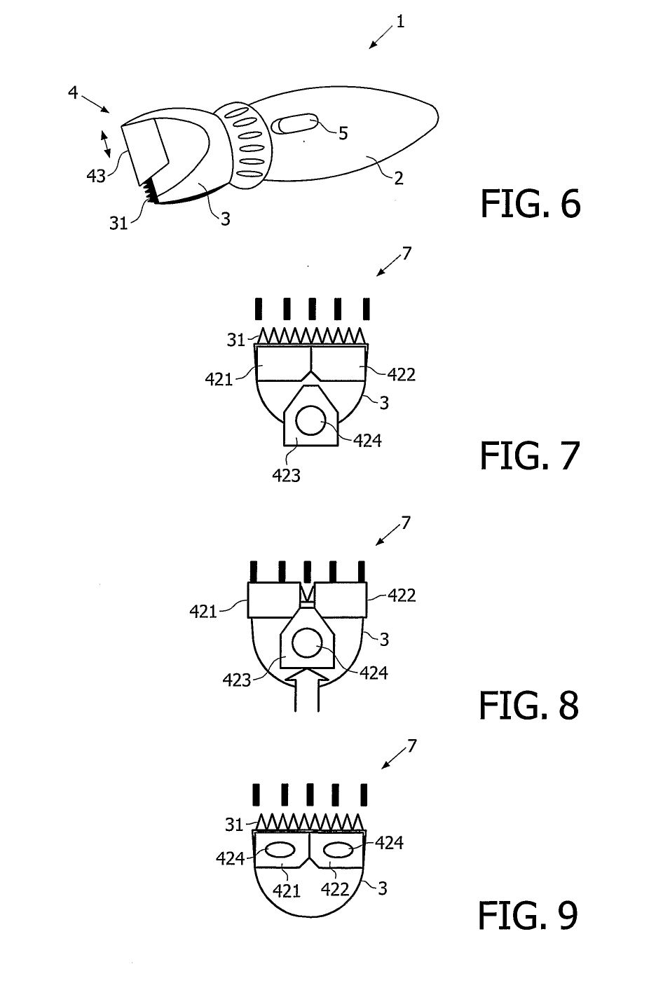

FIG. 7 shows schematically a first variant of the second embodiment in a first position;

FIG. 8 shows schematically a first variant of the second embodiment in a second position;

FIG. 9 show schematically a second variant of the second embodiment in a first position;

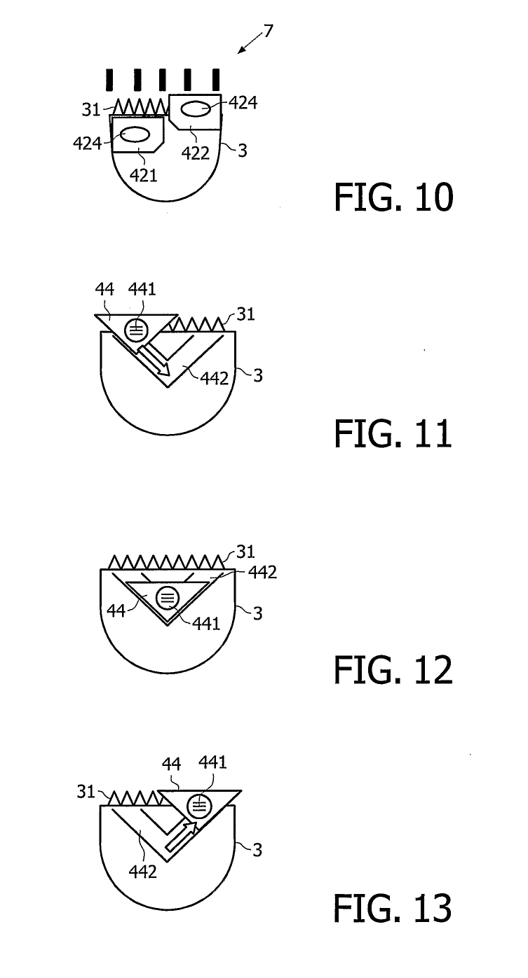

FIG. 10 shows schematically the second variant of the second embodiment in a second position;

FIG. 11 shows schematically a forth embodiment in a first position;

FIG. 12 shows schematically the forth embodiment in a second position;

FIG. 13 shows schematically the forth embodiment in a third position.

FIGS. 1 and 2 show a clipping device 1 having a casing 2 on which a cutting unit 3 is mounted. The casing 2 houses a motor and a battery or a connecting unit to an external power supply via a wire 6 (see FIG. 2) for feeding the motor. There could also be a rechargeable battery unit. The motor drives the cutting unit's blade 31, better visible in FIG. 2. Most clipping devices have in general two blades that are moved longitudinally with respect to one another by the motor for cutting. The motor is switched on and off with help of the switch 5. It will be understood, that the present invention can be applied to any clipping device regardless of the configuration of the cutting member(s) 31 of the cutting unit 3.

The length of the blade defines the maximum cut width that can be reduced with help of a cover means 4. In the specific example illustrated in FIGS. 1 and 2, the cover means 4 is arranged as comb unit 41. The comb unit 41 is attached, i.e. removably connected with the housing of the cutting unit 3. When the comb unit 41 is attached to the cutting unit 3, it covers the blade 31 of the cutting unit 3 with, in this case, with the help of a left and a right part of teeth 411 with closed interstices 412. The comb unit 41 makes the hair to be cut stand upright, but only the hair between the left and the right part of the comb unit 41 having teeth 411 with closed interstices 412 will actually be reached by the blade 31 and cut. Thus the distance between the left and the right part of the comb unit 41 with teeth 411 and closed interstices 412 defines the reduced cut width.

The clipping device as shown in FIGS. 1 and 2 is particularly useful for testing the cut length without removing to much hair. The actual cut length depends on the position of the comb unit 41 with respect to the blade 31. FIG. 1 illustrates the comb unit 41 in a position for minimum cut length and FIG. 2 illustrates the comb unit 41 in a position for maximum cut length. After testing the cut length in the various positions of the comb unit 41 and deciding, with which cut length to proceed, the comb unit 41 is removed and a conventional comb unit is attached to the clipping device 1, this conventional comb unit allowing for the maximal cut width.

An example for a comb unit 41 according to the invention is shown more in detail in FIGS. 3 and 4. FIG. 3 shows it form downside, i.e. the side applied to the skin. FIG. 4 shows it in the same perspective as in FIGS. 1 and 2. One will noticed that the interstices 412 between the teeth 411 on the left side and on the right side are closed, so as to shield the blade 31 of the cutting unit 3, when the comb unit 41 is attached. The attachment may be achieved by a snapping mechanism. When pushing the comb unit 41 over the cutting unit 3, the fixation 413 is guided in a direction parallel to the casing and can snap in various places along this direction, each snapping place being equivalent to a certain cut length. It will be understood that any known attachment method may be used for attaching the comb unit 41 to the casing 2 or the cutting unit 3.

A further preferred embodiment is illustrated in FIG. 5. According to this example, the cover means is configured as shield 42 that is integrated into the cutting unit 3. The shield 42 is countersunk in the cutting unit 3 next to the blade 31 in order to allow for the maximum cut width. If the user wishes to cut with only a reduced cut width, the shield 42 can be pushed up in a direction perpendicular to the blade 31 and, after use, back into the cutting unit 3. The movement of the shield 42 may for example be controlled electrically or mechanically, such as by using a small handle on the side of the cutting unit 3.

Another preferred embodiment is illustrated in FIG. 6. According to this example, the cover means 4 is arranged as cover 43. This cover 43 can be attached to the cutting unit 3 partly covering the blade 31, when it is needed. Preferably, the shield 43 is attached by using a snapping mechanism. But, of course, other ways of attaching are possible, such as using magnets and so on. Most preferably, the attachment is such, that the shield 43 may be moved in a direction parallel to the blade 31 in order to change the location of the reduced cut width form the right hand side to the left hand side of the cutting unit 3 and vice versa (see arrow). This is especially convenient, if different users use the same clipping device 1, some being sinistrals, some being right handers, or if the user wants to cut hair around one ear and then around the other ear. In another preferred embodiment, the shield 53 may not be removable, but still shiftable in a direction parallel to the blade 31.

The preferred embodiments illustrated in FIGS. 5 and 6 are particularly convenient for trimming or cutting hair with high precision. One advantage of the example shown in FIG. 5 is that the cover means 4 cannot get lost or be forgotten. Advantages of the example shown in FIG. 6 are, that the production costs are lower than for most other embodiments, that various covers 43 of different dimensions can be provided, thus defining different cut widths for one cutting unit 3, and that the side of the blade 31 with reduced cut width can be freely chosen.

FIGS. 7 and 8 schematically illustrate a variant of the embodiment of FIG. 5. A first shield 421 and a second shield 422 are countersunk in the cutting unit 3 beneath the blade 31, allowing for the maximum cut width defined by the length of the blade 31. Additionally, a conventional comb unit 7 is attached to the cutting unit 3. It should be noted, that all embodiments other then the embodiment with a cover means arranged as comb unit may be used in combination with a conventional comb unit.

If the user wants to use only a reduced cut width, he pushes both shields 421 and 422 up with the help of pushing means 423. The distance between shield 421 and shield 422 defines the cut width. Preferably, shields 421 and 422 are inside the cutting unit 3 to prevent damage of the shields 421 and 422. The pushing means 423 can be actuated by the user from the outside with help of grip 424. It will be understood, that the pushing means 423 can be actuated in other ways as well, e.g. electrically.

FIGS. 9 and 10 schematically illustrate a second variant of the embodiment shown in FIG. 5. Again, there are a first shield 421 and a second shield 422 countersunk in the cutting unit 3. But in this variant, the two shields 421 and 422 can be moved independently from one another as shown in FIG. 10. Each shield 421, 422 can be moved separately with help of its respective grip 424. Instead of moving the shields 421, 422 manually with help of the grips 424, they could be actuated e.g. electrically with help of switches. The variant of FIGS. 9 and 10 allows to change the location of the reduced cut width form the left hand side to the right hand side of the cutting unit and vice versa. By using asymmetric shields 421 and 422 one could provide different cut widths on these both sides.

It will be understood, that there may be simpler variants with only one shield or even more complex ones with more than two shields. All embodiments might be modified with respect to the number of parts of the cover means.

FIGS. 11 to 13 schematically illustrate a further preferred embodiment of the present invention based on a single shield 44. This shield 44 may be attached to the cutting unit 3 and exchangeable with other shields of other dimensions, or it may be fixed, i.e. irremovable, to the cutting unit 3. The shape of the single shield 44 and of a guidance 442, in which it slides, are adapted to each other to enable the single shield 44 to take three distinct positions: one for reduced cutting width on the right hand side of the cutting unit 3, one for reduced cutting width on the left hand side of the cutting unit 3 and one for maximum cut width. In the present example, a triangular shield 44 matched with a triangular guidance 442 has been chosen, leading to an overall movement that is substantially parallel to the blade 31. The user may move the single shield 44 manually by touching the grip 441 and pushing the shield 44 in the direction he wants. As with the other embodiments, other ways of actuating and moving the shield 44 are possible.

It will be noticed, that with all embodiments based on shields, the shields may be mounted outside or inside the cutting unit 3. There may be shields on both sides of the cutting members or only on one side. Preferably, the shield should be located so as to be between the cutting member and the hair to be cut, when in action.

It is noted that the preferred embodiments of the clipping device described herein in detail for exemplary purposes are of course subject to many different variations in structure, design, application and methodology. Because many varying and different embodiments may be made within the scope of the inventive concept herein taught, and because many modifications may be made in the embodiment herein detailed, it is to be understood that the details herein are to be interpreted as illustrative and not in a limiting sense. For example, various combinations of the features of the following dependent claims could be made with the features of the independent claim without departing from the scope of the present invention. Furthermore, any reference numerals in the claims shall not be construed as limiting scope.

### LIST OF REFERENCE NUMERALS

1 clipping device
2 casing
3 cutting unit
31 blade
4 cover means
41 comb unit
411 tooth
412 interstice
413 fixation
42 shield
421 first shield
422 second shield
423 pushing means
424 grip
43 cover
44 single shield
441 grip
442 guidance
5 switch
6 wire
7 conventional comb unit

1. A clipping device comprising
a casing,
a cutting unit at one end of the casing including one or more cutting members providing a given cut width,
wherein it further comprises
a cover means to be mounted on the casing and/or the cutting unit for covering the cutting members to reduce the cut width.

2. The clipping device of claim 1 wherein the cover means is configured as comb unit attachable to the casing and/or the cutting unit.

3. The clipping device of claim 2 wherein the comb unit includes a teeth part with closed interstices shielding the cutting members.

4. The clipping device of claim 1 wherein the cover means is attachable to the cutting unit.

5. The clipping device of claim 1 wherein the cover means is fixed to the cutting unit and/or casing and can be moved between a position providing the given cut width and a position providing a reduced cut width.

6. The clipping device of claim 5 wherein the cover means is integrated into the cutting unit.

7. The clipping device of claim 1 wherein the cover means includes two or more parts, the reduced cut width being equal to the distance of said two parts.

8. The clipping device of claim 1 wherein the cover means includes two or more parts that are independently movable in a direction perpendicular to the cutting members, each defining a reduced cut width.

9. The clipping device of claim 1 wherein the cover means is movable in a direction substantially parallel to the cutting members in order to change the location of the covered part of the cutting members with respect to the casing.

10. A comb unit for a clipping device as claimed in claim 1, attachable to the casing and/or the cutting unit to cover the one or more cutting members of the cutting unit to reduce the cut width, wherein it includes a teeth part with closed interstices shielding the cutting members.
